(19) United States
(12) Patent Application Publication
(10) Pub. No.: US 2006/0089808 A1
(43) Pub. Date: Apr. 27, 2006

(54) Conformational sampling by self-organization

(76) Inventors: Dimitris K Agrafiotis, Downington, PA (US); Huafeng Xu, San Francisco, CA (US); Sergei F Izrailev, New York, NY (US); Francis R Salemme, Yardley, PA (US)

Correspondence Address: WILSON SONSINI GOODRICH & ROSATI, 650 PAGE MILL ROAD, PALO ALTO, CA, 94304-1050, US

(21) Appl. No.: 10/519,638

(22) PCT Filed: Jun. 26, 2003
(86) PCT No.: PCT/US03/19905

§ 371 Date: Aug. 5, 2005

Related U.S. Application Data
(60) Provisional application No. 60/392,372, filed on Jul. 1, 2002.

(51) Int. Cl. G06F 19/00

(52) U.S. Cl. 702/19

(57) ABSTRACT

A self-organizing method, system, and computer program product for generating molecular conformations that are consistent with a set of distance and/or volume constraints. A stochastic proximity embedding (SPE) algorithm evaluates individual distance and/or volume constraints and adjusts the atomic coordinates to minimize violations of such constraints. The method scales linearly with thenumber of atoms, and produces many more unique conformations at a fraction of the time required by conventional distance geometry algorithms.

### BACKGROUND OF THE INVENTION

1. Field of the Invention

The present invention is directed to generating molecular conformations and, more particularly, to methods, systems, and computer program products for generating molecular conformations from distance and volume constraints.

2. Related Art

Finding a general, fast and reliable method for detecting low energy conformations of a molecule is one of the greatest challenges of computational chemistry. See, A. R. Leach, “Reviews in Computational Chemistry,” Vol. 2 (Eds.: K. B. Lipkowitz, D. B. Boyd), VCH, New York, 1991, incorporated herein by reference in its entirety.

Solving this problem requires a method for detecting minima on the potential energy surface. This is typically carried out by generating reasonable starting geometries and minimizing them to the nearest local energy minimum. This search can be performed in Cartesian, torsion, or distance space.

For a discussion of Cartesian space search methods, see D. M. Ferguson and D. J. Raber, J. Am. Chem. Soc. 1989, 111, 4371, and M. Saunders, J. Am. Chem. Soc. 1987, 109, 3150, incorporated herein by reference in their entireties.

For a discussion of torsion space search methods, see, W. L. Jorgensen and J. Tirado-Rives, J. Phys. Chem. 1996, 100, 14508; and G. Chang, W. C. Guida and W. C. Still, J. Am. Chem. Soc. 1989, 111, 4379, incorporated herein by reference in their entireties.

For a discussion of distance space search methods, see, G. M. Crippen and T. F. Havel, “Distance Geometry and Molecular Conformation,” Research Studies Press, Somerset, UK, 1988; and D. C. Spellmeyer, et al., J. Mol. Graphics Modell. 1997, 15, 18, incorporated herein by reference in their entireties.

The latter approach, known as distance geometry (DG), uses covalent constraints to establish a set of upper and lower interatomic distance bounds, and then attempts to generate conformations that are consistent with these bounds. DG has been successfully applied to a wide range of problems including conformational analysis, (see, D. C. Spellmeyer, et al., J. Mol. Graphics Modell, 1997, 15, 18; and B. P. Feuston, et al., J. Chem. Inf. Comput. Sci., 2001, 41, 754, incorporated herein by reference in their entireties), NMR structure determination (see, T. F. Havel and K. Wüithrich, J. Mol. Biol. 1985, 182, 281; C. Mumenthaler and W. Braun, J. Mol. Biol. 1995, 254, 465; and J. Kuszewski, et al., Journal of Biomolecular NMR 1992, 2, 33, incorporated herein by reference in their entireties), protein structure prediction (see, E. S. Huang and R. Samudrala, J. W. Ponder, Protein Sci. 1998, 7, 1998, incorporated herein by reference in its entirety), and ligand docking (see, E. C. Meng, et al., Proteins: Struct. Funct. Gene. 1993, 17, 266, incorporated herein by reference in its entirety).

DG involves four basic steps: 1) generating the interatomic distance bounds, 2) assigning a random value to each distance within the respective bounds, 3) converting the resulting distance matrix into a starting set of Cartesian coordinates, and 4) refining the coordinates by minimizing distance constraint violations. To ensure that reasonable conformations are generated, the original upper and lower bounds are usually refined using an iterative triangular smoothing procedure. Although this process improves an initial guess, the randomly chosen distances may still be inconsistent with a valid 3-dimensional geometry, necessitating expensive metrization schemes (see, J. Kuszewski, et al., Journal of Biomolecular NMR 1992, 2, 33; T. F. Havel and M. E. Snow, J. Mol. Biol. 1991, 217, 1; and T. F. Havel and K. Wüthrich, Bull. Math. Biol. 1984, 46, 673, incorporated herein by reference in their entiretiesf), or higher dimensional embeddings (see, D. C. Spellmeyer, et al., J. Mol. Graphics Modell. 1997, 15, 18, incorporated herein by reference in its entirety), prior to error refinement.

What is needed are methods, systems, and computer program products for generating low energy molecular conformations that overcome the limitations of conventional methods.

### SUMMARY OF THE INVENTION

The present invention is directed to methods, systems, and computer program products for generating molecular conformations. More particularly, the invention is directed to methods, systems, and computer program products for generating molecular conformations from interatomic distance and volume constraints.

In accordance with the present invention, a stochastic proximity embedding (SPE) algorithm evaluates and minimizes violations of distance and volume constraints in a set of atoms that constitute a molecule, a fragment of a molecule, or a union of molecules or molecular fragments. The atoms may be real or abstracted (dummy atoms, ring centroids, functional groups such as hydrogen bond donors or acceptors, etc).

The method includes:
(1) placing the set of atoms on a coordinate map;
(2) selecting a subset of atoms from the set of atoms, wherein the subset of atoms includes at least one associated constraint between the atoms in the subset;
(3) revising at least one coordinate of at least one atom from the selected subset of atoms on the map based on the at least one associated constraint when the at least one associated constraint is violated;
(4) repeating steps (2) and (3) for additional subsets of atoms from the set of atoms; and;
(5) outputting coordinates for the set of atoms.

Additional features and advantages of the invention will be set forth in the description that follows. Yet further features and advantages will be apparent to a person skilled in the art based on the description set forth herein or may be learned by practice of the invention. The advantages of the invention will be realized and attained by the structure particularly pointed out in the written description and claims hereof as well as the appended drawings.

It is to be understood that both the foregoing summary and the following detailed description are exemplary and explanatory and are intended to provide further explanation of the invention as claimed.

### BRIEF DESCRIPTION OF THE DRAWINGS/FIGURES

The present invention will be described with reference to the accompanying drawings, wherein like reference numbers indicate identical or functionally similar elements. Also, the leftmost digit(s) of the reference numbers identify the drawings in which the associated elements are first introduced.

FIG. 1A illustrates a typical conformation of an adamantane molecule generated by SPE.

FIG. 1B illustrates a typical conformation of an adenine molecule generated by SPE.

FIG. 1C illustrates a typical conformation of a fullerene molecule generated by SPE.

FIG. 2A illustrates a comparison of sampling efficiency between SPE and RUBICON for cycloheptadecane.

FIG. 2B illustrates a comparison of sampling efficiency between SPE and RUBICON for raloxifene.

FIG. 2C illustrates a comparison of sampling efficiency between SPE and RUBICON for Gleevec™.

FIG. 2D illustrates a comparison of sampling efficiency between SPE and RUBICON for [Met⁵]-enkephhalin.

FIG. 3A illustrates the chemical structure of raloxifene.

FIG. 3B illustrates the chemical structure of the free base of Gleevec™.

FIG. 3C illustrates a superimposition of the lowest energy structure discovered after minimization with the respective raw conformation produced by SPE for cycloheptadecane.

FIG. 3D illustrates a superimposition of the lowest energy structure discovered after minimization with the respective raw conformation produced by SPE for raloxifene.

FIG. 3E illustrates a superimposition of the lowest energy structure discovered after minimization with the respective raw conformation produced by SPE for Gleevec™.

FIG. 3F illustrates a superimposition of the lowest energy structure discovered after minimization with the respective raw conformation produced by SPE for [Met⁵]-enkephalin.

FIG. 4 is an example process flowchart 400 for implementing the SPE method.

FIG. 5 is a block diagram of an example computer system on which the present invention can be implemented.

FIG. 6 illustrates Table 1, which illustrates a comparison of CPU times required for the present invention and a conventional method.

### DETAILED DESCRIPTION OF THE INVENTION

The present invention is directed to methods, systems, and computer program products for generating molecular conformations. More particularly, the invention is directed to methods, systems, and computer program products for generating molecular conformations from interatomic distance and volume constraints.

A molecular conformation should satisfy a set of apparent constraints. The connectivity and common covalent bond lengths and angles require that the distance dᵢⱼ between any pair of atoms i and j fall between certain bounds, lᵢⱼ≦dᵢⱼ≦uᵢⱼ. Experimental data such as NOE measurements and contextual chemical intuition, such as contact pairs in a ligand-protein complex, can supply further distance constraints. These are usually supplemented by a set of volume constraints that prevent the signed volume Vᵢⱼₖₗ formed by four atoms i, j, k, l from exceeding certain limits. Volume constraints are used to enforce planarity of conjugate systems and correct chirality of stereocenters. The distance and volume constraints greatly reduce the number of accessible conformations to a molecule and the search space to be considered in conformational sampling.

In accordance with the present invention, violations of distance and volume constraints are assessed by the following error function:

$$S = {S}_{d} + {S}_{v} = {\sum }_{i < j} f ( {d}_{ij} , {l}_{ij} , {u}_{ij} ) + α {\sum }_{k} h ( {V}_{k} , {V}_{k}^{l} , {V}_{k}^{u} ) .$$

The first sum gives the violation of the distance constraints, where

$$f ( {d}_{ij} , {l}_{ij} , {u}_{ij} ) = {( \frac{{d}_{ij}^{2} - {l}_{ij}^{2}}{{l}_{ij}^{2}} )}^{2} if {d}_{ij} < {l}_{ij} , \\ f ( {d}_{ij} , {l}_{ij} , {u}_{ij} ) = {( \frac{{d}_{ij}^{2} - {u}_{ij}^{2}}{{u}_{ij}^{2}} )}^{2} if {d}_{ij} > {u}_{ij} , \\ and$$

$$f ( {d}_{ij} , {l}_{ij} , {u}_{ij} ) = 0 otherwise .$$

The second sum gives the violation of the volume constraints, where h(Vₖ,Vₖ^{l},Vₖ^{u})=(Vₖ−Vₖ^{l})² if Vₖ<Vₖ^{l}, h(Vₖ,Vₖ^{l},Vₖ^{u})=(Vₖ−Vₖ^{u})² if Vₖ>Vₖ^{u}, and h(Vₖ, Vₖ^{l},Vₖ^{u})=0 otherwise. α is a scaling factor used to balance the contributions to the total error from the distance and volume violations. Convention sets α=0.1. Minimizing the error function S with respect to the atomic coordinates generates conformations that satisfy the distance and volume constraints. Because there may be inconsistencies in the distance and/or volume constraints, it is often impossible to minimize S to 0.

A self-organizing method for minimizing the distance violation, S_{d}, is described and claimed in co-pending PCT application serial number (to be assigned—attorney docket number 1503.148PC01), titled, METHODS, SYSTEMS, AND COMPUTER PROGRAM PRODUCTS FOR REPRESENTING OBJECT RELATIONSHIPS IN A MULTIDIMENSIONAL SPACE, filed in the United States receiving office on Jun. 12, 2003. The method, referred to herein as stochastic proximity embedding (SPE), repeatedly selects a random pair of points (atoms) and moves their positions in the direction that minimizes the individual error function ƒ(dᵢⱼ, lᵢⱼ, uᵢⱼ). SPE has been shown to rapidly and reliably minimize the total distance error function S_{d}.

We conjecture that the method succeeds for the following reason. Suppose that all the distance constraints can be satisfied simultaneously. In that case, the global minimum of S_{d} is min(S_{d})=0, which is only achieved when all individual ƒ(dᵢⱼ, lᵢⱼ, uᵢⱼ)=0. Thus repeatedly bringing random individual ƒ(dᵢⱼ, lᵢⱼ, uᵢⱼ) toward their minimum results in the global minimum of S_{d}. By virtue of continuity, the algorithm works even when the distance constraints have very small inconsistencies and cannot be satisfied simultaneously.

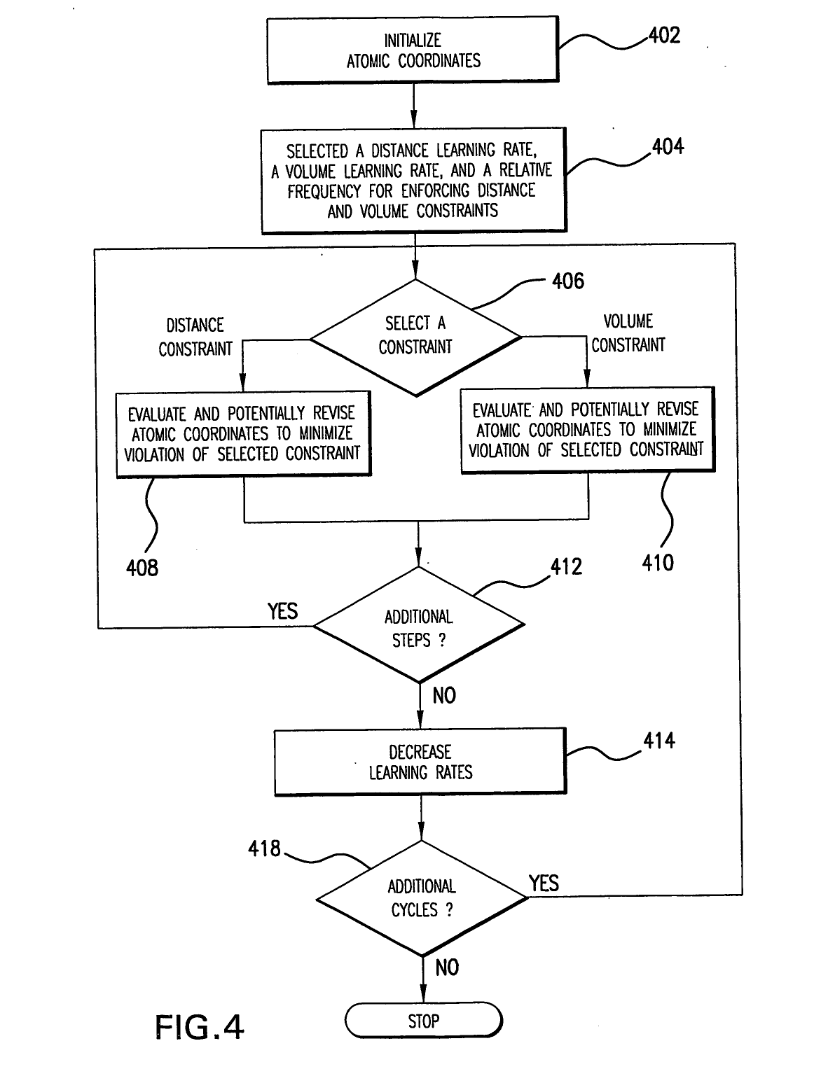

In accordance with the present invention, SPE is applied to minimize the total error function S. The volume error function Sᵥ is also comprised of a sum of individual contributions, and reaches the minimum min(Sᵥ)=0 when every individual h(Vₖ, Vₖ^{l}, Vₖ^{u})=0, provided that the constraints are consistent and can be satisfied simultaneously. Each individual h(Vₖ, Vₖ^{l}, Vₖ^{u}) involves four atoms. Similar to our procedure for minimizing S_{d}, we randomly select a volume constraint k, and move the positions of the four atoms involved in the direction that minimizes the individual error h(Vₖ,Vₖ^{l},Vₖ^{u}). An example method for implementing the invention, illustrated in FIG. 4, is now described.

1. (Step 402) Randomly place the atoms in a box of appropriate size (e.g., initialize the atomic coordinates).

2. (Step 404) Select a distance learning rate λ_{d}, a volume learning rate λᵥ, and a relative frequency for enforcing distance and volume constraints, ν.

3. (Step 406) With probability ν, do step (408); otherwise, do step (410).

4. (Step 408) Randomly select a pair of atoms, i and j, and compute their distance dᵢⱼ=∥xᵢ−xⱼ∥. If lᵢⱼ≦dᵢⱼ≦uᵢⱼ, leave the atomic positions unchanged. Otherwise, update the coordinates xᵢ and xⱼ by:

$${x}_{i} ← {x}_{i} + {λ}_{d} \frac{1}{2} \frac{{t}_{ij} - {ⅆ}_{ij}}{{ⅆ}_{ij} + ɛ} ( {x}_{i} - {x}_{j} )$$

$$and$$

$${x}_{j} ← {x}_{j} + {λ}_{d} \frac{1}{2} \frac{{t}_{ij} - {ⅆ}_{ij}}{{ⅆ}_{ij} + ɛ} ( {x}_{j} - {x}_{i} )$$

where tᵢⱼ is the nearest bound to dᵢⱼ (i.e., tᵢⱼ=lᵢⱼ if dᵢⱼ<lᵢⱼ, or tᵢⱼ=uᵢⱼ if dᵢⱼ>uᵢⱼ, and ε is a small number used to avoid division by zero.

5. (Step 410) Randomly select a volume constraint k, and the four atoms involved, p, q, s, t. Compute the signed volume V_{pqst} formed by the four atoms. If Vₖ^{l}<V_{pqst}<Vₖ^{l}, leave the atom positions unchanged. Otherwise, compute the gradient of the signed volume with respect to the atomic positions, g_{μ}=∇_{μ}V_{pqst}, where μ=p, q, s, t, and update the atomic coordinates by:

$${x}_{μ} ← {x}_{μ} + {λ}_{v} ( {V}_{k}^{0} - {V}_{pqst} ) \frac{{g}_{μ}}{{\sum }_{β = p , q , s , t} {\vert {g}_{μ} \vert}^{2}}$$

where Vₖ⁰ is the nearest bound to V_{pqst} (i.e., Vₖ⁰=Vₖ^{l} if V_{pqst}<Vₖ^{l}, or Vₖ⁰=Vₖ^{u} if V_{pqst}>Vₖ^{u}.

6. (Step 412) Repeat steps (406) through (410) for a prescribed number of steps, S.

7. (Step 414) Decrease the learning rates λ_{d} and λᵥ by prescribed decrements δλ_{d} and δλᵥ.

8. (Step 418) Repeat steps (406) through (414) for a prescribed number of cycles, C.

A reasonable set of parameters for the method is: λ_{d}=λᵥ=1.0, C=50, δλ_{d}=δλ_{d}=0.9/C, S=50×N, and

$$v = max ( 0.5 , 1 - 8.0 \times \frac{‖ V ‖}{N ( N + 1 ) / 2 + ‖ V ‖} ) ,$$

where N is the number of atoms in the molecule, and ∥V∥ is the total number of volume constraints. Alternative parameters may also be used.

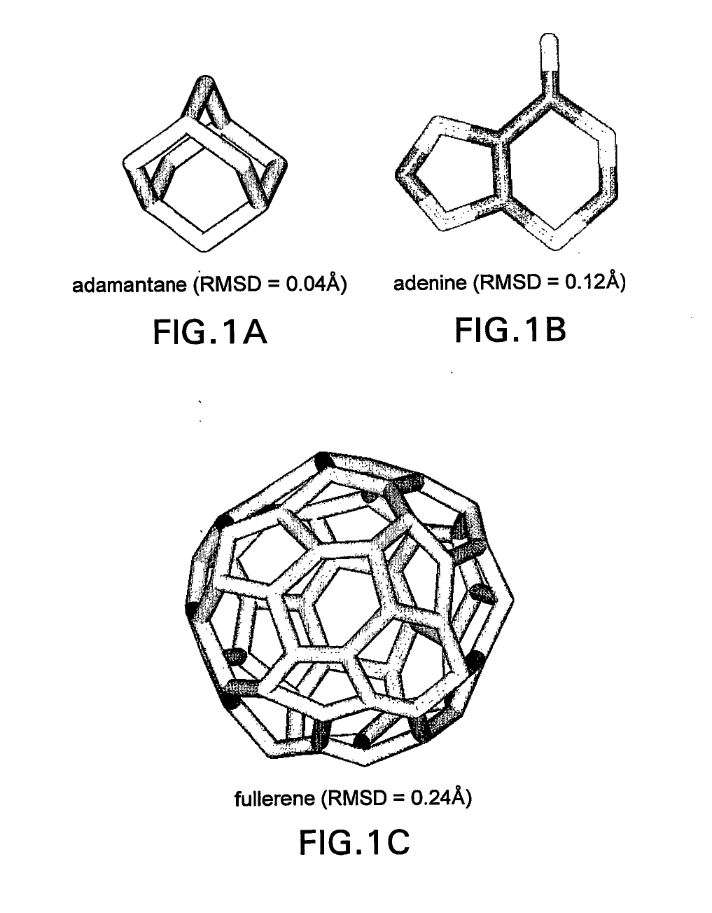

When applied to rigid molecules, the method always finds the correct conformation. For example, FIGS. 1A through 1C illustrate typical conformations of rigid molecules generated by SPE. More particularly, FIG. 1A illustrates a typical conformation of an adamantane molecule. FIG. 1B illustrates a typical conformation of an adenine molecule. FIG. 1C illustrates a typical conformation of a fullerene molecule.

SPE succeeds in generating good conformations because it capitalizes on the redundancy of the distance matrix and the cooperative nature of the atomic refinements—moving one pair of atoms towards satisfying their distance constraints simultaneously improves many other distances involving these atoms.

For flexible molecules, the global minimum is usually unknown. The merits of the invention can, however, be assessed by comparison to another method. As an example, four well-known molecules were examined—cycloheptadecane, raloxifene, the free base of Gleevec™ (imatinib mesylate), and [Met⁵]-enkephalin (sequence YGGFM)—and the conformations generated by SPE were compared to those generated by the widely used RUBICON DG program (Daylight Chemical Information Systems, www.daylight.com). To ensure statistical significance, 10,000 different conformations were generated by each program using an identical set of rules. Because RUBICON rejects conformations with large constraint violations, it generated only 8086 conformations for raloxifene, 9669 conformations for Gleevec™, and 8034 conformations for [Met⁵]-enkephalin. The chirality of the D-amino acids in each conformation of [Met⁵]-enkephalin was checked and no violation was found for either method.

The comparison was based on several criteria: the speed of generating the initial conformations, the coverage of energetically favorable conformations, the rate of discovering distinct conformations, and the lowest energy obtained during the entire search. Since the geometries obtained by DG are rather crude by energy standards, the conformations generated by the two methods were locally minimized using the Merck Molecular Force Field (MMFF94) prior to the comparison. (See, T. A. Halgren, J. Comput. Chem. 1996, 17, 616; T. A. Halgren, J. Comput. Chem. 1996, 17, 490; T. A. Halgren, J. Comput. Chem. 1996, 17, 520; T. A. Halgren, J. Comput. Chem. 1996, 17, 553; and T. A. Halgren and R. B. Nachbar, J. Comput. Chem. 1996, 17, 587, all of which are incorporated herein by reference in their entireties).

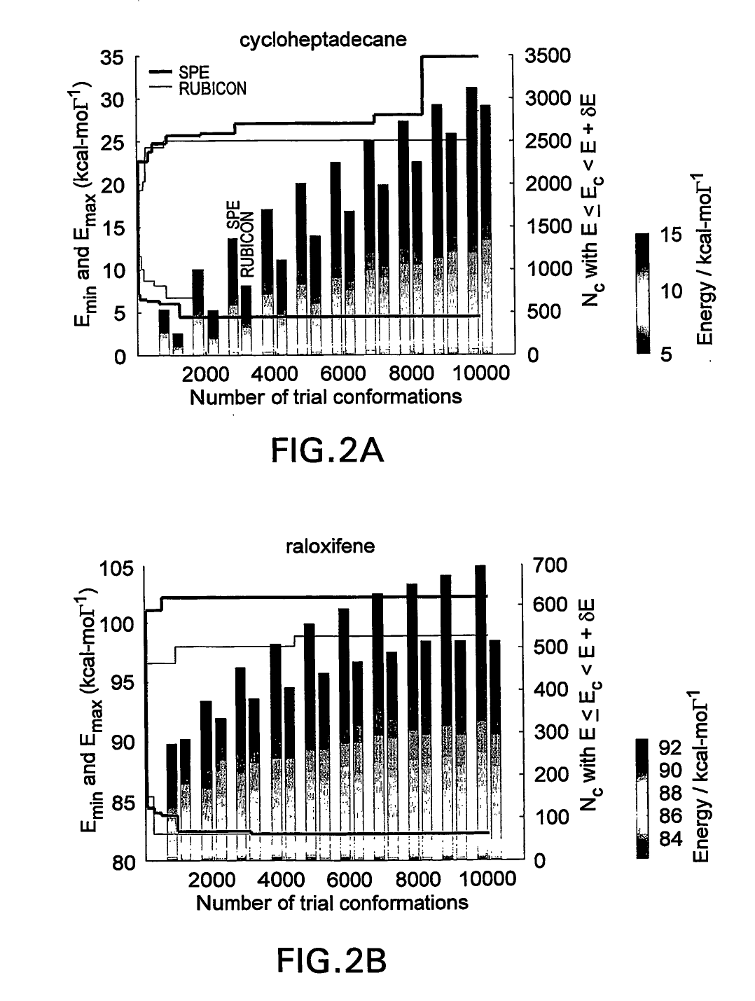

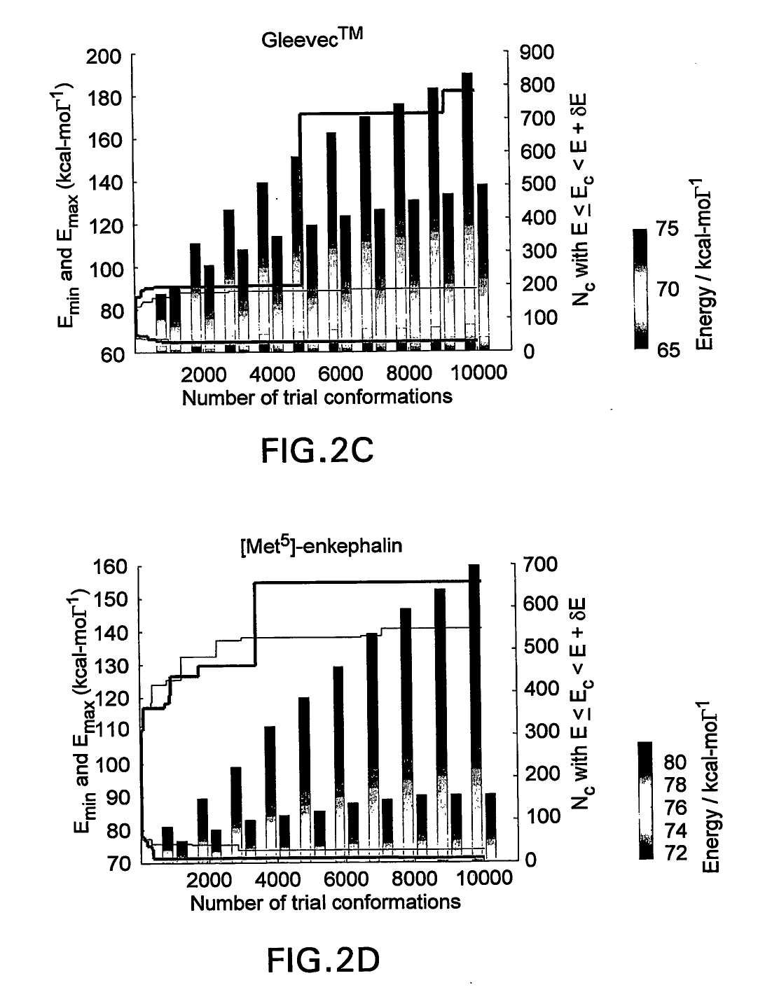

A method should be fast, should generate more conformations that minimize to unique low energy structures, and should quickly identify the global minimum. Benefits of SPE are now described with reference to Table 1 and FIGS. 2A through 2D.

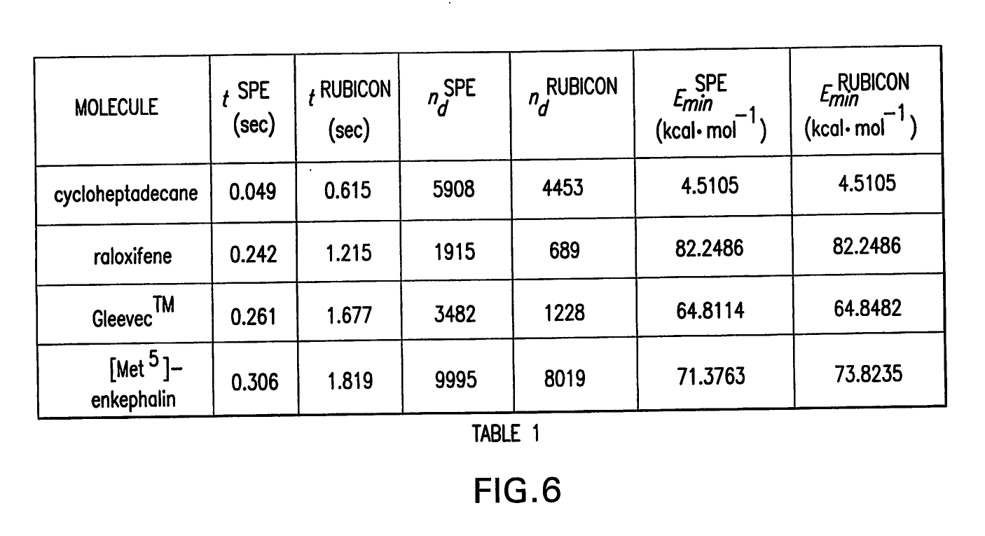

Table 1 in FIG. 6, illustrates the raw CPU time t^{method} required to generate one conformation by the specified method (SPE or RUBICON), the number of distinct conformations n_{d}^{method} discovered within 10,000 trials, and the lowest energy minimum Eₘᵢₙ^{method} for each molecule found by that method. t^{method} is computed by dividing the total CPU time by the number of trial conformations, and does not include energy minization. Two conformations were considered distinct if, after local energy minimization, they differ by an RMSD larger than 0.05 Å.

FIGS. 2A through 2D illustrate a comparison of sampling efficiency between SPE and RUBICON. More particularly, FIG. 2A illustrates a comparison of sampling efficiency between SPE and RUBICON for cycloheptadecane. FIG. 2B illustrates a comparison of sampling efficiency between SPE and RUBICON for raloxifene. FIG. 2C illustrates a comparison of sampling efficiency between SPE and RUBICON for Gleevec™. FIG. 2D illustrates a comparison of sampling efficiency between SPE and RUBICON for [Met⁵]-enkephhalin.

In FIGS. 2A through 2D, the solid lines show the minimum and maximum energy (Eₘᵢₙ and Eₘₐₓ discovered by the two methods after a number of trials, with the energy values indicated by the left ordinate of each plot (thick lines for SPE, thin lines for RUBICON). The bar graphs show the number of distinct conformations N_{C} found by each method after a number of trials (SPE on the left, RUBICON on the right), with the numbers listed on the right ordinate of each plot. Since usually only the energetically favorable conformations are of chemical interest, only the conformations whose minimized energies are within 10.0 kcal·mol⁻¹ from the global minimum are included. Each bar is further divided into 20 segments that represent non-overlapping energy intervals of 0.5 kcal·mol⁻¹ from the global minimum to 10.0 kcal·mol⁻¹ above, and whose corresponding energy values are indicated by the color map to the right of each plot. The length of each segment shows the number of distinct conformations whose minimized energies fall within the corresponding energy interval.

As illustrated in Table 1 and FIGS. 2A through 2D, SPE outperforms RUBICON on all counts. Indeed, SPE was up to an order of magnitude faster in generating the raw conformations, and these consistently minimized to more distinct conformations in all four cases (two conformations were considered distinct if the corresponding minimized structures differed by more than 0.05 Å in RMSD). For raloxifene, Gleevec™, and [Met⁵]-enkephalin, the difference was even more pronounced in the low energy region, as manifested by the significantly longer segments of blue color for SPE than RUBICON in the bar graphs in FIGS. 2A through 2D.

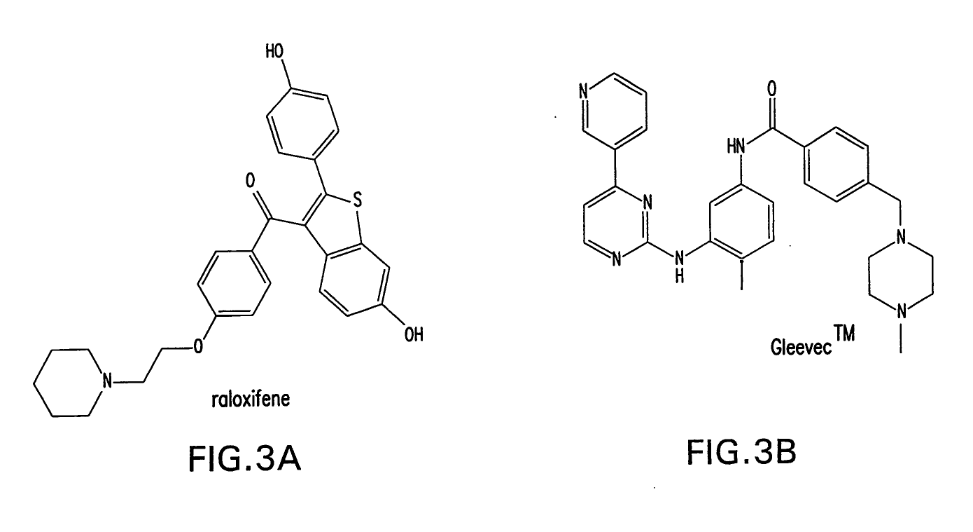

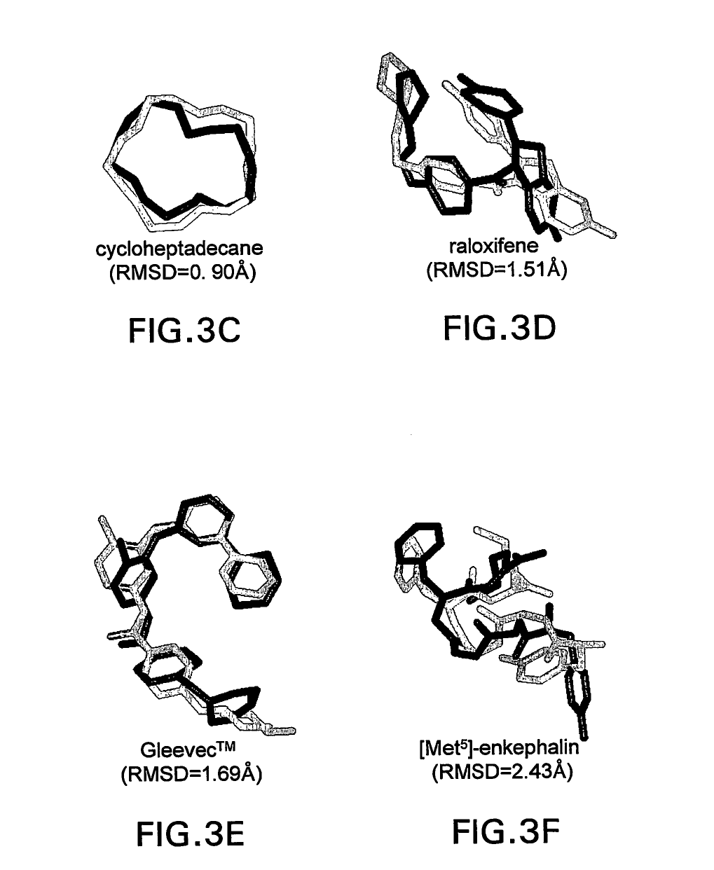

For example, for [Met⁵]-enkephalin, SPE discovered 69 distinct conformations with minimized energy within 5.0 kcal·mol⁻¹ above the lowest energy minimum, whereas RUBICON discovered only 9. SPE was also superior in locating the lowest energy structure—both methods found the same global energy minima for cycloheptadecane and raloxifene, but RUBICON failed to find the lowest energy minima of Gleevec™ and [Met⁵]-enkephalin discovered by SPE. In addition, SPE finds the global minimum in a smaller or comparable number of trials. The lowest energy structures discovered after minimization superimposed with the respective raw conformations produced by SPE are shown in FIGS. 3A through 3F.

FIG. 3A illustrates the chemical structure of raloxifene. FIG. 3B illustrates the free base of Gleevec™.

FIGS. 3C through 3F illustrate superimpositions of the lowest energy structures discovered after local minimization (blue) with the respective raw conformations produced by SPE (red). The corresponding RMSDs are shown in the parentheses. More specifically, FIG. 3C illustrates cycloheptadecane. FIG. 3D illustrates raloxifene. FIG. 3E illustrates Gleevec™. FIG. 3F illustrates [Met5]-enkephalin.

Although the specific details of the comparison may differ depending on the energy function employed, the raw speed and the diversity of the conformations that SPE generates should remain.

The present invention can be implemented in one or more computer systems capable of carrying out the functionality described herein. For example, and without limitation, the process flowchart 400, or portions thereof, can be implemented in a computer system.

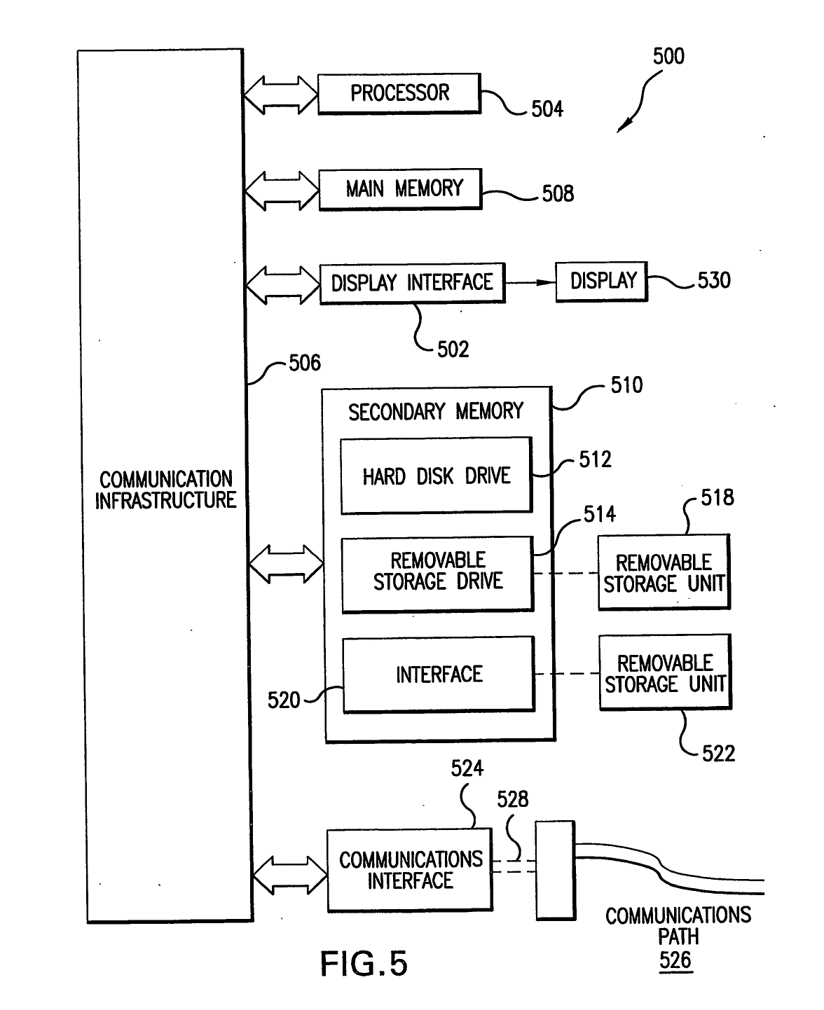

FIG. 5 illustrates an example computer system 500. Various software embodiments are described in terms of this example computer system 500. After reading this description, it will be apparent to a person skilled in the relevant art(s) how to implement the invention using other computer systems and/or computer architectures.

The example computer system 500 includes one or more processors 504. Processor 504 is connected to a communication infrastructure 502.

Computer system 500 also includes a main memory 508, preferably random access memory (RAM).

Computer system 500 can also include a secondary memory 510, which can include, for example, a hard disk drive 512 and/or a removable storage drive 514, which can be a floppy disk drive, a magnetic tape drive, an optical disk drive, etc. Removable storage drive 514 reads from and/or writes to a removable storage unit 518 in a well known manner. Removable storage unit 518, represents a floppy disk, magnetic tape, optical disk, etc. which is read by and written to by removable storage drive 514. Removable storage unit 518 includes a computer usable storage medium having stored therein computer software and/or data.

In alternative embodiments, secondary memory 510 can include other devices that allow computer programs or other instructions to be loaded into computer system 500. Such devices can include, for example, a removable storage unit 522 and an interface 520. Examples of such can include a program cartridge and cartridge interface (such as that found in video game devices), a removable memory chip (such as an EPROM, or PROM) and associated socket, and other removable storage units 522 and interfaces 520 that allow software and data to be transferred from the removable storage unit 522 to computer system 500.

Computer system 500 can also include a communications interface 524, which allows software and data to be transferred between computer system 500 and external devices. Examples of communications interface 524 include, but are not limited to a modem, a network interface (such as an Ethernet card), a communications port, a PCMCIA slot and card, etc. Software and data transferred via communications interface 524 are in the form of signals 528, which can be electronic, electromagnetic, optical or other signals capable of being received by communications interface 524. These signals 528 are provided to communications interface 524 via a signal path 526. Signal path 526 carries signals 528 and can be implemented using wire or cable, fiber optics, a phone line, a cellular phone link, an RF link and other communications channels.

In this document, the terms “computer program medium” and “computer usable medium” are used to generally refer to media such as removable storage unit 518, a hard disk installed in hard disk drive 512, and signals 528. These computer program products are means for providing software to computer system 500.

Computer programs (also called computer control logic) are stored in main memory 508 and/or secondary memory 510. Computer programs can also be received via communications interface 524. Such computer programs, when executed, enable the computer system 500 to perform the features of the present invention as discussed herein. In particular, the computer programs, when executed, enable the processor(s) 504 to perform the features of the present invention. Accordingly, such computer programs represent controllers of the computer system 500.

In an embodiment where the invention is implemented using software, the software can be stored in a computer program product and loaded into computer system 500 using removable storage drive 514, hard disk drive 512 or communications interface 524. The control logic (software), when executed by the processor(s) 504, causes the processor(s) 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like and combinations thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for generating atomic coordinates from a set of interatomic distance and/or volume constraints, the method comprising the steps of:
(1) placing a set of atoms on a coordinate map;
(2) selecting a subset of atoms from the set of atoms, wherein the subset of atoms includes at least one associated constraint between the atoms in the subset;
(3) revising at least one coordinate of at least one atom from the selected subset of atoms on the coordinate map based on the at least one associated constraint when the at least one associated constraint is violated;
(4) repeating steps (2) and (3) for additional subsets of atoms from the set of atoms; and
(5) generating coordinates for the set of atoms.

2. The method of claim (1), wherein the set of constraints includes a set of distance constraints.

3. The method of claim (1), wherein the set of constraints includes a set of volume constraints.

4. The method of claim (2), wherein the subset of atoms includes two atoms.

5. The method of claim (3), wherein the subset of atoms includes four atoms.

6. The method of claim (1), wherein the set of atoms includes at least one real atom.

7. The method of claim (1), wherein the set of atoms includes at least one abstracted atom.

8. The method of claim (1), wherein the subset of atoms is chosen at random.

9. The method of claim (1), wherein the subset of atoms is chosen with a probability that depends on whether the at least one associated constraint is a distance constraint or a volume constraint.

10. The method according to claim (1), wherein step (3) comprises the step of adjusting at least one coordinate of at least one atom from the selected subset of atoms on the coordinate map by a correction factor so that the degree of violation of at least one associated constraint is improved upon adjusting the at least one coordinate.

11. The method according to claim (10), further comprising the steps of repeating steps (2) through (4) for several correction factors.

12. The method of claim (1), further comprising the step of:
(6) generating the distance and volume constraints from connectivity and covalent bond lengths and angles associated with the selected set of atoms.
